(19) United States
(12) Patent Application Publication
(10) Pub. No.: US 2008/0007968 A1
(43) Pub. Date: Jan. 10, 2008

(54) Double-layer lamp and backlight module having same field of the invention

(75) Inventors: Peng Lei, Shenzhen (CN); Wen-Hui Yao, Shenzhen (CN)

Correspondence Address: WEI TE CHUNG;FOXCONN INTERNATIONAL, INC., 1650 MEMOREX DRIVE, SANTA CLARA, CA, 95050, US

(73) Assignee: INNOLUX DISPLAY CORP.

(21) Appl. No.: 11/825,917

(22) Filed: Jul. 9, 2007

(30) Foreign Application Priority Data
Jul. 7, 2006 (TW) 95124890

(51) Int. Cl. F21V 14/00

(52) U.S. Cl. 362/614; 362/260; 362/255

(57) ABSTRACT

An exemplary double-layer lamp (210) includes an inner cold cathode fluorescent lamp (CCFL) (211), an outer glass tube (212) accommodating the inner CCFL therein, and a reflecting member (214) disposed between the inner CCFL and the outer glass tube. An exemplary backlight module (200) applies the above double-layer lamp. The backlight module has a smaller volume.

### FIELD OF THE INVENTION

The present invention relates to a double-layer lamp, and a backlight module having the double-layer lamp.

### GENERAL BACKGROUND

Liquid crystal devices (LCDs) are commonly used as displays for compact electronic apparatuses. This is because LCDs not only provide good quality images using little power, but are also conveniently thin. Because liquid crystal in an LCD does not emit any light itself, the liquid crystal requires a light source to clearly and sharply display texts and images. Therefore, LCDs typically require a backlight module.

Referring to FIG. 9, a typical backlight module 100 includes a light source 112, a reflecting shell 114, and a light guide plate (LGP) 120 with a light incident surface 121. The light source 112 is disposed in a space cooperatively formed by the reflecting shell 114 and the LGP 120. The light source 112 is adjacent to the light incident surface 121 of the LGP 120. The light source 112 is generally a cold cathode fluorescent lamp (CCFL) emitting light uniformly in all directions. The reflecting shell 114 is used to reflect and concentrate light, so that the light propagates along predetermined directions toward the light incident surface 121 of the LGP 120.

Referring to FIG. 10, this is an enlarged, cross-sectional view of the light source 112. The light source 112 is a double-layer lamp, which includes an inner cold cathode fluorescent lamp (CCFL) 1121 and an outer glass tube 1122. The outer glass tube 1122 accommodates the inner CCFL 1121. Thus, the outer glass tube 1122 can protect the inner CCFL 1121 from being broken. The outer glass tube 1122 can also isolate the inner CCFL 1121 from ambient air, so that a temperature of the inner CCFL 1121 is stably maintained.

However, the reflecting shell 114 adds to the cost of the backlight module 100, and also adds to the overall volume occupied by the backlight module 100.

What is needed, therefore, is a double-layer lamp that can overcome the above-described deficiencies. What is also needed is a backlight module employing the double-layer lamp.

### SUMMARY

In one preferred embodiment, a double-layer lamp includes an inner cold cathode fluorescent lamp (CCFL), an outer glass tube, accommodating the inner CCFL therein, and a reflecting member disposed between the inner CCFL and the outer glass tube.

Other novel features and advantages will become more apparent from the following detailed description when taken in conjunction with the accompanying drawings.

### BRIEF DESCRIPTION OF THE DRAWINGS

FIG. 1 is an exploded, isometric view of a backlight module according to a first embodiment of the present invention, the backlight module including a light source.

FIG. 2 is an enlarged, cross-sectional view of part of the backlight module of FIG. 1 after the backlight module has been assembled, showing a cross-section of the light source.

FIG. 3 is an enlarged view of the light source shown in FIG. 2.

FIG. 4 is similar to FIG. 3, but showing a corresponding view in the case of a light source of a backlight module according to a second embodiment of the present invention.

FIG. 5 is similar to FIG. 3, but showing a corresponding view in the case of a light source of a backlight module according to a third embodiment of the present invention.

FIG. 6 is similar to FIG. 3, but showing a corresponding view in the case of a light source of a backlight module according to a fourth embodiment of the present invention.

FIG. 7 is similar to FIG. 3, but showing a corresponding view in the case a light source of a backlight module according to a fifth embodiment of the present invention.

FIG. 8 is similar to FIG. 3, but showing a corresponding view in the case of a light source of a backlight module according to a sixth embodiment of the present invention.

FIG. 9 is a schematic, side cross-sectional view of part of a conventional backlight module, the backlight module including a light source.

FIG. 10 is an enlarged view of the light source shown in FIG. 9.

### DETAILED DESCRIPTION OF PREFERRED EMBODIMENTS

Reference will now be made to the drawing figures to describe the various embodiments of the present invention in detail.

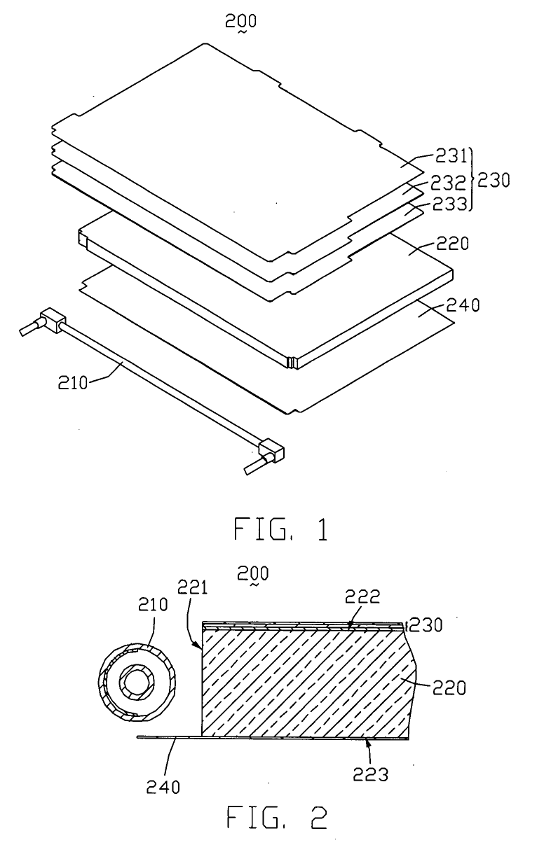

Referring to FIG. 1, this shows a backlight module 200 according to a first embodiment of the present invention. The backlight module 200 includes an optical film assembly 230, a light guide plate (LGP) 220, a reflecting plate 240, and a light source 210. The optical film assembly 230 includes a first brightness enhancing film 231, a second brightness enhancing film 232, and a diffusing film 233, disposed in that order from top to bottom.

Referring also to FIG. 2, the LGP 220 includes a light emitting surface 222, a bottom surface 223 opposite to the light emitting surface 222, and a light incident surface 221 adjacent the light emitting surface 222. The optical film assembly 230 is disposed on the light emitting surface 222. The reflecting plate 240 is disposed on the bottom surface 223. The light source 210 is disposed adjacent the light incident surface 221. The light source 210 is parallel to both the light incident surface 221 and the light emitting surface 222. The light source 210 is a linear lamp.

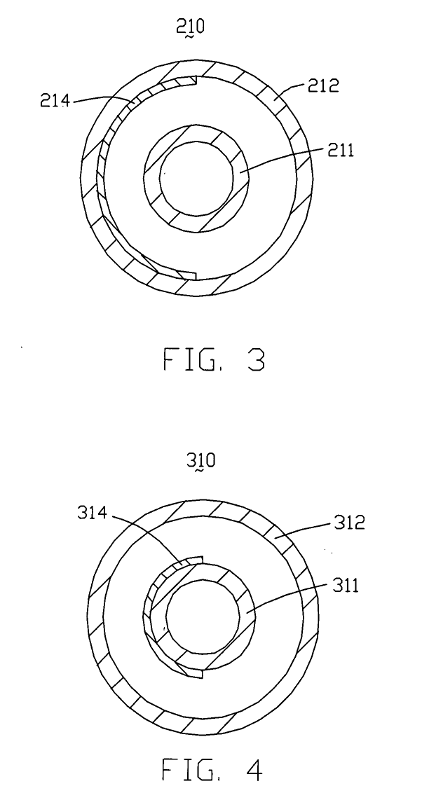

Referring also to FIG. 3, the light source 210 is a double-layer lamp. The light source 210 includes an outer glass tube 212, an inner CCFL 211, and a reflecting element 214. The inner CCFL 211 is received in the outer glass tube 212. In particular, two opposite ends of the inner CCFL 211 can be fixed at two opposite ends of the outer glass tube 212 using a pair of holding elements (not visible). The reflecting element 214 is disposed on part of an inner surface (not labeled) of the outer glass tube 212, in a position farthest from the light incident surface 221. In the illustrated embodiment, the reflecting element 214 is disposed on half of the inner surface of the outer glass tube 212. That is, a transverse cross-section of the reflecting element 214 is a semicircle. The reflecting element 214 can be a piece of reflecting material attached to the inner surface of the outer glass tube 212. For example, the piece of reflecting material can be an aluminum sheet, which is adhered to the inner surface of the outer glass tube 212. In another example, the reflecting element 214 can be a reflecting layer made from silver, which is coated on the inner surface of the outer glass tube 212.

In operation of the backlight module 200, part of light emitted by the inner CCFL 211 transmits directly out of the light source 210 through the outer glass tube 212 before entering the light incident surface 221 of the LGP 220. Another part of the light emitted by the inner CCFL 211 is reflected by the reflecting element 214, and then transmits out of the light source 210 through the outer glass tube 212 before entering the light incident surface 221. The overall effect is that the light emitted by the inner CCFL 211 transmits to the LGP 220 uniformly and in a relatively concentrated beam. Unlike in conventional art, the backlight module 200 employing the double-layer lamp as the light source 210 does not need a reflecting shell. This can reduce the cost of the backlight module 200, and minimize an overall volume occupied by the backlight module 200.

Referring to FIG. 4, a light source 310 of a backlight module according to a second embodiment of the present invention is similar to the light source 210 of the first embodiment. However, a reflecting element 314 of the light source 310 is disposed on part of an outer surface (not labeled) of an inner CCFL 311, in a position farthest from a corresponding light incident surface of an LGP. In the illustrated embodiment, the reflecting element 314 is disposed on half of the outer surface of the inner CCFL 311. In operation of the backlight module, part of light emitted by the inner CCFL 311 transmits directly out of the light source 310 through an outer glass tube 312 before entering the light incident surface. Another part of the light emitted by the inner CCFL 311 is reflected by the reflecting element 314, and then transmits out of the light source 310 through the outer glass tube 312 before entering the light incident surface. The overall effect is that the light emitted by the inner CCFL 311 transmits to the LGP uniformly and in a relatively concentrated beam.

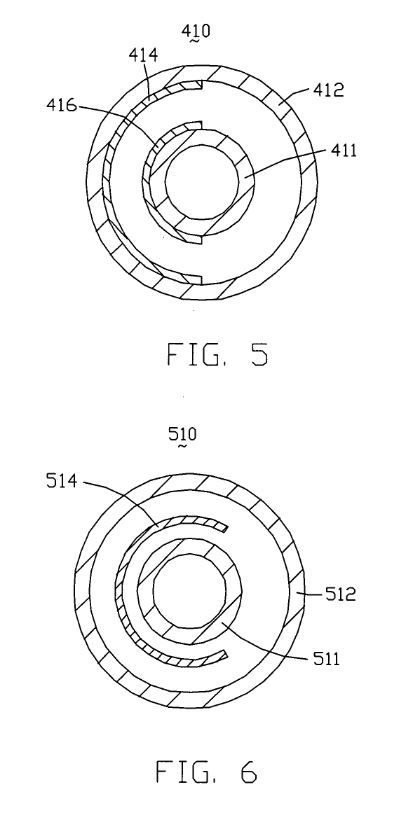

Referring to FIG. 5, a light source 410 of a backlight module according to a third embodiment of the present invention is similar to the light source 210 of the first embodiment. However, the light source 410 includes two reflecting elements 414, 416. The reflecting element 414 is disposed on part of an inner surface (not labeled) of an outer glass tube 412. The reflecting element 416 is disposed on part of an outer surface (not labeled) of an inner CCFL 411. In operation of the backlight module, part of light emitted by the inner CCFL 411 transmits directly out of the light source 410 through the outer glass tube 412 before entering a corresponding light incident surface of an LGP. Another part of the light emitted by the inner CCFL 411 is reflected by the reflecting element 416, and most of such light then transmits out of the light source 410 through the outer glass tube 412 before entering the light incident surface. Any of such light that does not transmit thus is reflected by the reflecting element 414, and then transmits out of the light source 410 through the outer glass tube 412 before entering the light incident surface. The overall effect is that the light emitted by the inner CCFL 411 transmits to the LGP 220 uniformly and in a relatively concentrated beam.

Referring to FIG. 6, a light source 510 of a backlight module according to a fourth embodiment of the present invention is similar to the light source 210 of the first embodiment. However, a reflecting element 514 of the light source 510 is disposed at a middle region of a space between an outer glass tube 512 and an inner CCFL 511. In the illustrated embodiment, the reflecting element 514 is generally C-shaped. That is, the reflecting element 514 covers more than half of the inner CCFL 511. Two opposite ends of the reflecting element 514 can be fixed at two opposite ends of the outer glass tube 512 using a pair of holding elements (not visible). The space is a vacuum.

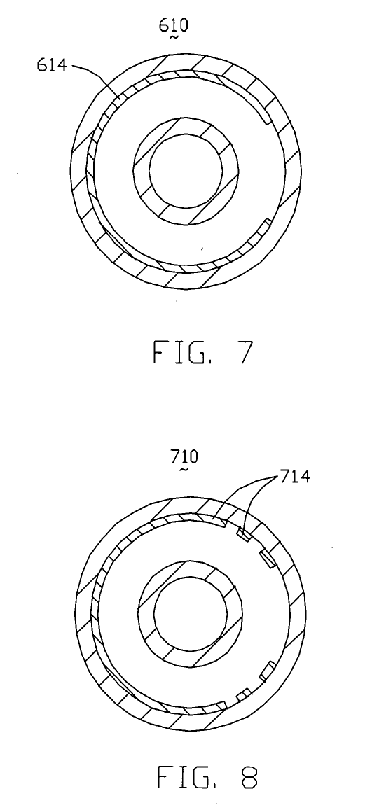

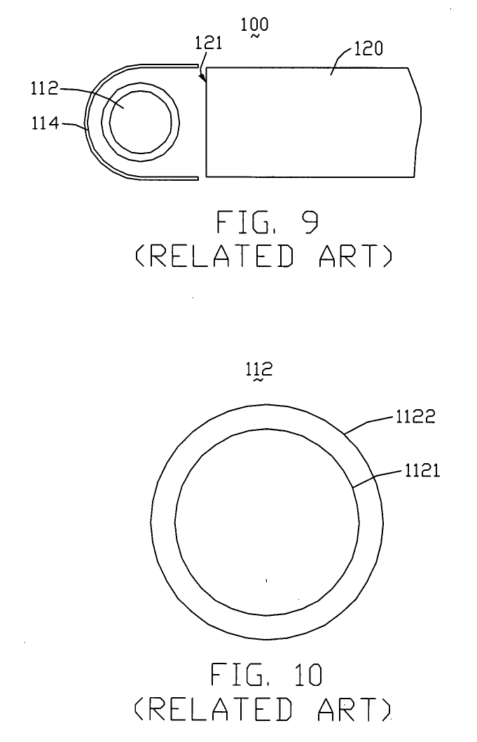

Referring to FIG. 7, a light source 610 of a backlight module according to a fifth embodiment of the present invention is similar to the light source 210 of the first embodiment. However, a reflecting element 614 of the light source 610 is generally C-shaped. That is, a transverse cross-section of the reflecting element 614 is an arc that is greater than a semicircle.

Referring to FIG. 8, a light source 710 of a backlight module according to a sixth embodiment of the present invention is similar to the light source 610 of the fifth embodiment. However, a reflecting element 714 of the light source 710 is generally C-shaped, with opposite ends of the reflecting element 714 being discontinuous. That is, a transverse cross-section of the reflecting element 714 is an arc that is greater than a semicircle. The reflecting element 714 can be considered to include a central semicircular portion, and portions at opposite sides of the semicircular portion respectively. The portions at opposite sides of the semicircular portion are discontinuous.

It is to be understood, however, that even though numerous characteristics and advantages of the present embodiments have been set out in the foregoing description, together with details of the structures and functions of the embodiments, the disclosure is illustrative only, and changes may be made in detail, especially in matters of shape, size, and arrangement of parts within the principles of the invention to the full extent indicated by the broad general meaning of the terms in which the appended claims are expressed.

What is claimed is:

1. A double-layer lamp, comprising:
an inner cold cathode fluorescent lamp (CCFL);
an outer glass tube, accommodating the inner CCFL therein; and
a reflecting member disposed between the inner CCFL and the outer glass tube.

2. The double-layer lamp as claimed in claim 1, wherein the reflecting member is disposed at part of an inner surface of the outer glass tube, and surrounds at least half of the inner CCFL.

3. The double-layer lamp as claimed in claim 2, wherein a transverse cross-section of the reflecting member is a semicircle.

4. The double-layer lamp as claimed in claim 2, wherein a transverse cross-section of the reflecting member is an arc greater than a semicircle.

5. The double-layer lamp as claimed in claim 2, wherein the reflecting member is discontinuous at least one of two opposing end portions thereof.

6. The double-layer lamp as claimed in claim 1, wherein the reflecting member is disposed at part of an outer surface of the inner CCFL.

7. The double-layer lamp as claimed in claim 1, further comprising another reflecting member, one of the reflecting members is disposed at part of an inner surface of the outer glass tube, the other reflecting member is disposed at part of an outer surface of the inner CCFL.

8. The double-layer lamp as claimed in claim 1, wherein the reflecting member is disposed at a middle region of a space between the outer glass tube and the inner CCFL.

9. The double-layer lamp as claimed in claim 1, wherein the reflecting member is a reflecting layer coated on either an inner surface of the outer glass tube or an outer surface of the inner CCFL.

10. The double-layer lamp as claimed in claim 1, wherein the reflecting member is a piece of reflecting material.

11. The double-layer lamp as claimed in claim 10, wherein the reflecting member is adhered on either an inner surface of the outer glass tube or an outer surface of the inner CCFL.

12. The double-layer lamp as claimed in claim 1, wherein the reflecting member comprises silver.

13. A backlight module, comprising:
a light guide plate, having a light incident surface; and
a light source adjacent to the light incident surface, the light source comprising:
an inner CCFL;
an outer glass tube, accommodating the inner CCFL therein; and
a reflecting member disposed between the inner CCFL and the outer glass tube.

14. The backlight module as claimed in claim 13, wherein the reflecting member is disposed at part of an inner surface of the outer glass tube, and surrounds at least half of the inner CCFL.

15. The backlight module as claimed in claim 14, wherein a transverse cross-section of the reflecting member is a semicircle.

16. The backlight module as claimed in claim 14, wherein a transverse cross-section of the reflecting member is an arc greater than a semicircle.

17. The backlight module as claimed in claim 13, wherein the reflecting member is disposed on part of an outer surface of the inner CCFL.

18. The backlight module as claimed in claim 13, wherein the light source further comprises another reflecting member, one of the reflecting members is disposed on part of an inner surface of the outer glass tube, the other reflecting member is disposed on part of an outer surface of the inner CCFL.

19. The backlight module as claimed in claim 13, wherein the reflecting member is disposed at a middle region of a space formed between the outer glass tube and the inner CCFL.

20. The backlight module as claimed in claim 13, wherein the reflecting member is a reflecting layer coated on either an inner surface of the outer glass tube or an outer surface of the inner CCFL.
